(19) United States
(12) Patent Application Publication
(10) Pub. No.: US 2007/0167074 A1
(43) Pub. Date: Jul. 19, 2007

(54) Connection system

(76) Inventor: Ian J. Palmer, East Gosford (AU)

Correspondence Address: 3M INNOVATIVE PROPERTIES COMPANY, PO BOX 33427, ST. PAUL, MN, 55133-3427, US

(21) Appl. No.: 10/551,868

(22) PCT Filed: Apr. 1, 2004
(86) PCT No.: PCT/US04/09986

§ 371 Date: Nov. 2, 2006

(30) Foreign Application Priority Data
Apr. 2, 2003 (AU) 2003901531
Jun. 27, 2003 (AU) 2003903269

(51) Int. Cl. H01R 13/73

(52) U.S. Cl. 439/571

(57) ABSTRACT

A junction box to seal the contents from the effects of dust and moisture while providing convenient access inside the box. In the invention provides a connection system for communication media that includes: (a) a housing defining an internal cavity and an opening to allow access; (b) one or more apertures extending through the housing to the cavity, each aperture adapted to receive communications media; (c) one or more connectors mounted within the cavity adapted to interconnect the communications media extending through the aperture(s); and (d) a cover adapted to cooperate with the housing to define an air reservoir containing at least a portion of the housing including the opening, the reservoir and the housing cooperating to prevent fluid entering the cavity. Also provided is an apparatus for conveniently raising and lowering the junction box in and out of a below ground cavity.

### FIELD OF THE INVENTION

The present invention relates to a connection system and a method for interconnecting communications media and in particular to a waterproof junction box for interconnecting communications media below ground level.

### BACKGROUND

Currently, there is a requirement for communications media, such as fibre optic, copper, coaxial cables, or the like to be interconnected at various locations in order to provide communication services over distributed areas, such as to individual's houses, or the like. This is typically achieved by providing junction boxes to interconnect wires, with the junction boxes being buried underground in a convenient location.

It will be appreciated that as the junction boxes typically contain electrical connections and optionally other electronic apparatus, then it is important that the contents of the junction box are protected from contaminants such as dust and moisture. This may be achieved in a number of ways.

In one example, junction boxes are provided in the form of a sealable reinforced plastic container. In use, communications media are connected via connectors in the junction box. The box is then closed and sealed using a rubber seal which is compressed between two housing portions. The junction box may then be positioned underground, or the like as required.

An example of a prior art system for housing electrical apparatus is described in U.S. Pat. No. 2,247,936. This document describes a system in which inner and outer casings are provided, the inner casing being adapted to hold the electrical apparatus in use. The outer casing, which has a substantially tubular shape, is sealed at one end so that it may be positioned over the inner casing with the open end facing the ground. In use, when water rises above the level of the open end of the outer casing, this causes air to become trapped in the outer casing. The air pressure of the trapped air prevents water rising within the outer casing, and hence prevents water entering the inner casing and effecting the electrical apparatus.

### SUMMARY

There is a need to provide a junction box which can successfully seal the contents from the effects of dust and moisture. It is desirable to provide convenient access to the inside of the box, with an arrangement that is durable and easy to maintain.

In a first broad form the present invention provides, a connection system for interconnecting communication media, the connection system including:
a) A housing defining an internal cavity, the housing including an opening to thereby allow access to the cavity;
b) One or more apertures extending through the housing to the cavity, each aperture being adapted to receive respective communications media;
c) One or more connectors mounted within the cavity, the connectors being adapted to interconnect the communications media extending through the aperture(s);
d) A cover adapted to cooperate with the housing to define an air reservoir containing at least a portion of the housing including the opening, the reservoir and the housing cooperating to prevent fluid entering the cavity.

Typically the connection system further includes a lid adapted to be removably mounted into the opening to thereby seal the cavity.

The connectors may be coupled to a frame, the frame being pivotally mounted to the housing to move between:
a) A first position in which the frame is contained in the cavity; and,
b) A second position in which the frame extends through the opening to thereby allow access to the connectors.

The cavity can have first and second cavity portions, the connectors being mounted in the first cavity portion, the housing and cover being arranged such that the first cavity portion is contained in the air reservoir.

The aperture(s) may extend into the first cavity portion. Alternatively, the apertures may extend in to the second cavity portion, depending on the desired arrangement.

The second portion of the housing may be adapted to receive further connectors and/or control systems.

The housing may have first and second opposing ends, the opening being positioned at the first of the housing, the second end of the housing forming a base.

The cover can be formed from an upper member having side members extend substantially perpendicularly therefrom, the cover being positioned adjacent the opening in use, such that the side members extend towards the base.

The connection system typically further includes a container having a container opening to thereby allow the housing and cover to be positioned in the container in use.

The container may be positioned in the ground in use, with the housing positioned below ground level, with the communications media extending into the container through an aperture from a below ground level conduit.

In a second broad form the present invention provides a container for containing a connection system for interconnecting communication media, the container including:
a) A cavity;
b) A loading system mounted in the cavity, the loading system being formed from:
   i) A support adapted to support the connection system in use;
   ii) A drive system positioned in a first end of the container, the drive system being coupled to the support to selectively move the support between:
      (1) A retracted position in which the connection system is supported in the container below ground level; and,
      (2) An extended positioned in which at least a portion of the connection system extends above ground level.

Typically the support is formed from two or more tines extending laterally across the container.

The drive system typically includes a winch coupled to one end of the container to thereby allow the support to be manually winched between the retracted and extended positions. However, alternative systems, such as powered drive systems may also be used.

The connection system may be a connection system according to the first broad form of the invention.

In this case, the support is preferably adapted to cooperate with the housing defining the first cavity portion.

In a third broad form the present invention provides a method of interconnecting communications media, the method including:
a) Extending the communications media into an internal cavity defined by a housing through one or more apertures, the housing having an opening therein to thereby allow access to the cavity;
b) Interconnecting the media using one or more connectors mounted within the cavity; and,
c) Positioning a cover over the housing such that the housing and cover cooperate to define an air reservoir containing at least a portion of the housing including the opening, the reservoir and the housing cooperating to prevent fluid entering the cavity.

The method of extending the communications media through the aperture can include:
a) Inserting the communications media into the cavity through the aperture(s); and,
b) Sealing the aperture, to thereby prevent fluid entering or leaving the cavity through the aperture.

The method typically further includes positioning the housing in a container through a container opening.

The method may further include:
a) Positioning the housing adjacent the container;
b) Extending the communications media into the cavity;
c) Interconnecting the communications media; and,
d) Positioning the housing in the container.

The housing typically has first and second opposing ends, the opening being positioned at the first of the housing, the second end of the housing forming a base, the cover being formed from an upper member having side members extend substantially perpendicularly therefrom. In this case, the method preferably includes positioning the cover adjacent the opening in use, such that the side members extend towards the base.

The method may further include removably mounting a lid in the opening to thereby seal the cavity.

The method typically includes using a connection system according the first broad form of the present invention.

In a fourth broad form the present invention provides a method of loading a connection system into a container, the method including using a loading system to position the housing in the container, the loading system including:
a) A support adapted to support the housing in use;
b) A drive system positioned in a first end of the container, the drive system being coupled to the support to selectively move the support between:
   i) A retracted position in which the housing is supported in the container below ground level; and,
   ii) An extended positioned in which at least a portion of the housing extends above ground level;
the method including positioning the housing in the container by:
   (1) Placing the support in the extended position;
   (2) Positioning the connection system such that the connection system is supported by the support;
   (3) Moving the support to the retracted position.

Typically the support is formed from two or more tines extending laterally across the container.

The connection system is typically a connection system according to the first broad form of the invention.

The method of interconnecting the communications media may include:
a) Positioning the housing such that the housing is supported by the support, with the support in the extended position;
b) Placing the frame in the second position;
c) Interconnecting the communications media;
d) Placing the frame in the first position;
e) Removably mounting a lid in the opening to thereby seal the cavity;
f) Positioning a cover over the housing such that the housing and cover cooperate to define an air reservoir containing at least a portion of the housing including the opening, the reservoir and the housing cooperating to prevent fluid entering the cavity; and,
g) Moving the support to the retracted position.

The method of interconnecting the communications media may be a method according to the third broad form of the invention.

In a fifth broad form the present invention provides a system for protecting contents against immersion in a fluid, the system including:
a) A housing defining an internal cavity for containing the contents, the housing including an opening to thereby allow access to the cavity; and,
b) A cover adapted to cooperate with the housing to define an air reservoir containing at least a portion of the housing including the opening, the reservoir and the housing cooperating to prevent fluid entering the cavity.

The cover is generally formed from a base member having a number of side members extending perpendicularly thereto, the base member and sided members being arranged such that the side and base members cooperate with the housing to define an air reservoir.

The housing typically has a base for supporting the housing in use, and a top opposite the base, wherein in use, the cover is adapted to be positioned adjacent the top such that the side members extend toward the base.

In this case the opening is preferably in the top.

In a sixth broad form the present invention provides a method of protecting contents against immersion in a fluid, the method including:
a) Placing the contents in a housing defining an internal cavity, the housing including an opening to thereby allow access to the cavity; and,
b) Mounting a cover to the housing, the cover being adapted to cooperate with the housing to define an air reservoir containing at least a portion of the housing including the opening, the reservoir and the housing cooperating to prevent fluid entering the cavity.

### BRIEF DESCRIPTION OF THE DRAWINGS

Exemplary embodiments of the present invention will now be described with reference to the accompanying drawings, in which:

FIG. 1 is a schematic side view of an embodiment of a junction box according to the present invention;

FIG. 2 is a schematic plan view of the junction box of FIG. 1;

FIG. 3 is a cross sectional view along the line A-A of FIG. 2;

FIG. 4 is a cross sectional view along the line B-B of FIG. 3;

FIG. 5 is a cross sectional view of the junction box of FIG. 1 along the line A-A when immersed in water;

FIG. 6 is a schematic plan view of the junction box of FIG. 1 including processing electronics;

FIG. 7 is a cross sectional view along the line C-C in FIG. 6;

FIG. 8 is a schematic plan view of a frame for use in the junction box of FIG. 1;

FIG. 9 is a schematic plan view of the junction box of FIG. 1 incorporating the frame of FIG. 8;

FIG. 10 is a schematic side view of the junction box of FIG. 8 with the frame in a closed position;

FIG. 11 is a schematic side view of the junction box of FIG. 8 with the frame in an open position;

FIG. 12 is a schematic side view of a pit for receiving the junction box of FIG. 1;

FIG. 13 is a schematic side view of the pit of FIG. 12 including a loading device;

FIG. 14 is a schematic plan view of the pit of FIG. 13;

FIG. 15 is a schematic side view of the pit of FIG. 13 and junction box of FIG. 1 with the loading system in the extended position;

FIG. 16 is a schematic plan view of the pit and junction box of FIG. 15;

FIG. 17 is a schematic end view of the pit and junction box of FIG. 15;

FIG. 18 is a schematic side view of the pit of FIG. 13 and junction box of FIG. 1 with the loading system in the retracted position;

FIG. 19 is a schematic end view of the pit and junction box of FIG. 18 with the loading system in the retracted position;

FIG. 20 is a schematic side view of a second embodiment of a junction box according to the present invention;

FIG. 21 is a cross sectional view of the junction box of FIG. 20;

FIG. 22 is a schematic side view of the pit of FIG. 13 and the junction box of FIG. 20.

FIG. 23A is a schematic side view of a third embodiment of a junction box according to the present invention;

FIG. 23B is a schematic plan view of the junction box of FIG. 23A;

FIG. 23C is a schematic end view of the junction box of FIG. 23A;

FIG. 23D is a schematic end view of the junction box of FIG. 23A mounted in the pit of FIG. 12;

FIG. 24A is a schematic side view of a third embodiment of a junction box according to the present invention;

FIG. 24B is a schematic plan view of the junction box of FIG. 24A;

FIG. 24C is a schematic end view of the junction box of FIG. 24A; and,

FIG. 24D is a schematic end view of the junction box of FIG. 24A mounted in the pit of FIG. 12.

### DETAILED DESCRIPTION

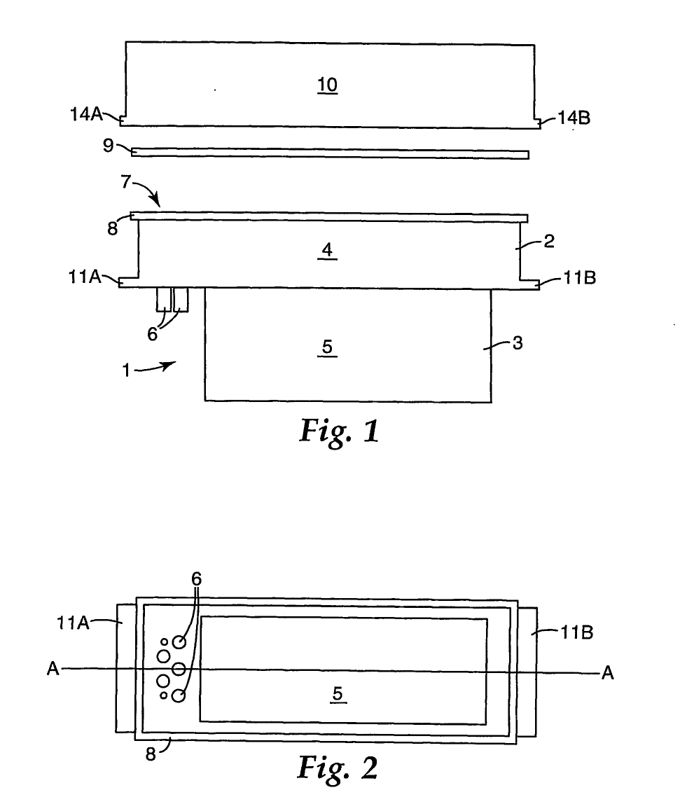

An exemplary embodiment will now be described with reference to FIGS. 1, 2, 3, and 4, which show an embodiment of a connection system according to the present invention.

The connection system includes a housing 1, having upper and lower portions 2, 3 defining respective upper and lower cavities 4, 5. An aperture 6 is provided to allow communications media, such as copper wire, fibre optic, coaxial cables or the like (hereinafter referred to generally as “cables”) to be inserted into the cavity 4, as will be explained in more detail below.

An opening 7 provides access to the cavities 4, 5. An upper lip 8 is provided around the perimeter of the opening 7, as shown. The lip 8 is adapted to cooperate with a lid 9, to allow the lid 9 to be removably mounted to the upper housing 2. In use, the lid 9 may be attached to the lip 8 by a variety of attaching means, such as screws, clips, or the like. The lid may also be provided with a seal (not shown) to prevent moisture and dust entering the cavities 4, 5.

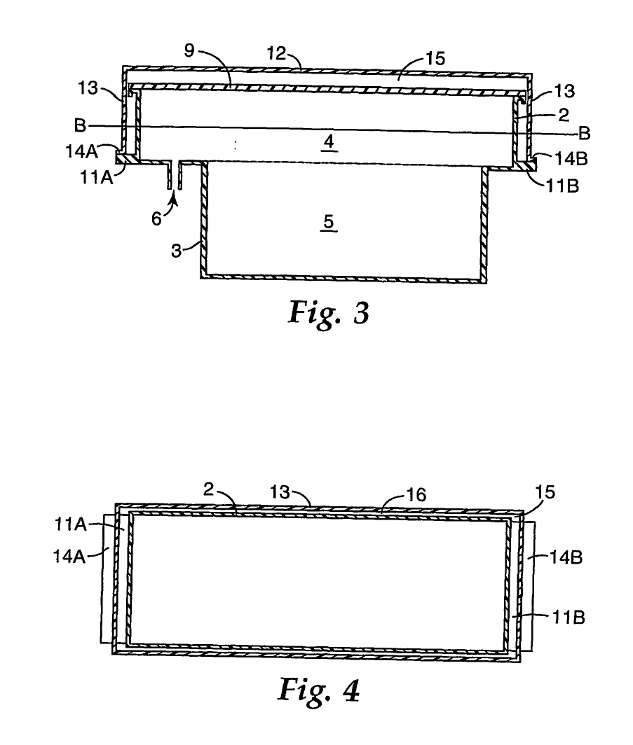

Two lower lips 11A, 11B are provided at either end of the upper housing 2. The lips 2 are provided to allow a cover 10 to be mounted over the upper housing 2, as shown in FIGS. 3 and 4. The cover includes an upper member 12, side members 13 and two lips 14A, 14B. The lips 14A, 14B may be attached to the lips 11A, 11B, using suitable fixing means such as screws, clips or the like, to thereby secure the cover 10 to the housing 1. Alternatively, the cover may be held in position by other techniques, as described for example in FIG. 19.

In any event, the positioning of the cover 10 over the housing 1 in use forms an air reservoir, shown generally at 15. As shown in FIG. 4, as the cover is not a flush fit with respect to the housing 1, this allows air to flow in and out of the reservoir 15 via a space between the upper housing 2 and the side members 13, as shown at 16.

In use, the connection system is adapted to be placed in the ground, to allow underground cables to be connected to each other. The cables are inserted into the apertures 6, which are then sealed to prevent water, dust and air flowing into or out of the cavities 4, 5. This may be achieved using any one of a number of sealing techniques and products such as Cold Shrink Tubing (CST), available from 3M Company, St. Paul, Minn., USA, which is an open ended tubular rubber sleeve of high stretch rubber that has been factory expanded and assembled onto a removable hollow core. CST Tubing may be formed from rubber, silicon rubber, or the like and can be coupled to the aperture 6 and then extended over the cables, as will be appreciated by persons skilled in the art. Alternatively, a seal between the aperture 6 and the cable can be achieved using, mastic rubber, self bonding sealing tape, adhesive lined heat shrink PVC tubing, or the like

The presence of the lid 9 will prevent dust and moisture from entering the cavities 4, 5 thereby protecting the electrical connections therein. In an exemplary embodiment, the presence of the lid and the arrangements disclosed herein can provide protection at a rating of IP4 and IP5 according to “(AS 1939-1990)-IEC529-1989 degrees of protection provided by enclosures for electrical equipment (IP code)”: IP4 protection corresponds to protection against foreign objects of 1.0 mm diameter or greater and, IP5 corresponds to protection against dust.

However, the presence of the lid 9 may not generally be sufficient to protect the junction box against immersion in water, for example during flooding or heavy rain. In some applications, it is desirable that junction boxes of this form are capable or providing protection at a standard of between IP6 and IP8, according to the above mentioned standard, where IP8 indicates that the housing provides “Protection against the effects of prolonged immersion in specified conditions”.

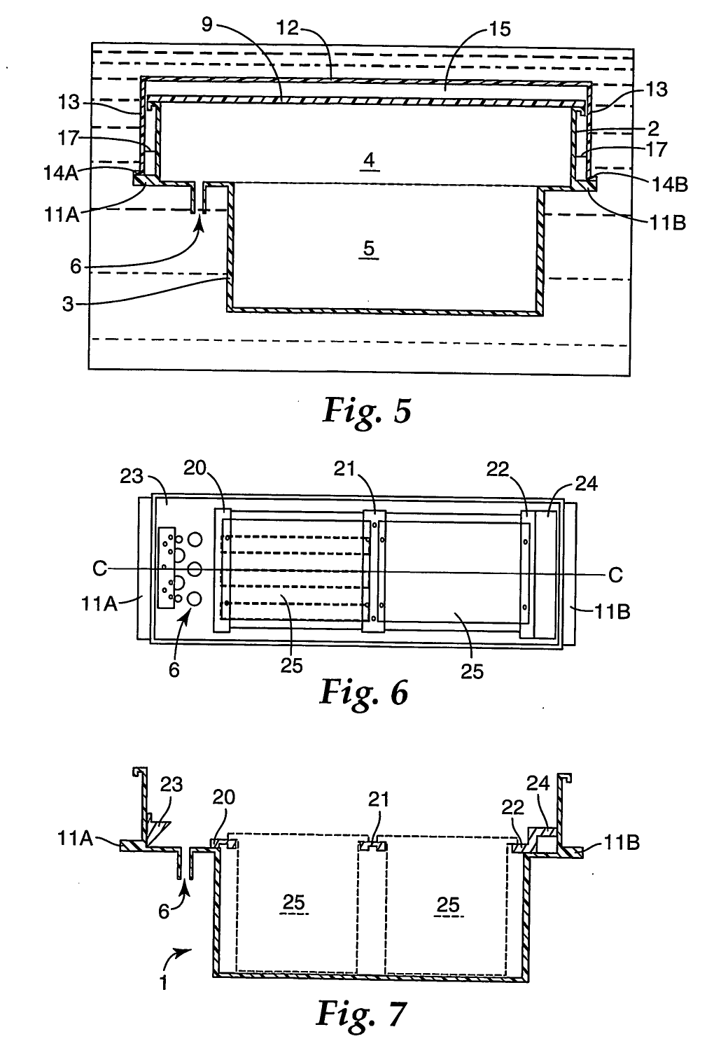

Accordingly in an exemplary embodiment, this additional level of protection may be provided by the presence of the cover 10, and the air reservoir 15 trapped therein. In particular, in the event that the junction box is immersed in water as seen in FIG. 5, as the water level rises to immerse the housing 1, the rising water level will cause air to be trapped in the air reservoir as shown at 15. The air pressure in the air reservoir 15 prevents water rising up the level of the housing to the upper lip 8, with the maximum level the water reaches being shown at 17, thereby preventing water entering the cavity.

This is important as it is generally difficult to provide a seal between the lip 9 and the lip 8 which is sufficiently water tight, and yet easy to remove to allow access to the cavities 4, 5.

In addition to this, the air in the air reservoir 15 provides pressure balance to compensate for temperature changes. In particular, if the housing 1 cools, the air in the cavities 4, 5 will also cool and contract. This causes air to flow from the air reservoir 15 into the cavities 4, 5 balancing the pressure change. It will be appreciated that this will reduce the air pressure in the air reservoir, which will in turn be compensated for by a slight rise in the water level 17. However, the rise in the water level will only be small and would not greatly effect the ability of the system to resist immersion in water.

It will be appreciated that in general, the maximum level 17 to which the water will rise will depend on a number of factors including the depth of immersion, and the volume of air in the reservoir. In this embodiment, in order to protect contents of the housing 1 against immersion in water depths of up to 500 mm, the cover is adapted to contain over four litres of air. However it will be appreciated that the volume of the air reservoir can be adjusted depending on the desired level of immersion protection required.

In order to allow the cables to be interconnected, the housing 1 is can be provided in an exemplary embodiment with first and second sets of supports 20, 21, 22, and, 23, 24, as shown in FIGS. 6 and 7. In this embodiment, the supports 22, 24 are incorporated into a single element, but it will be appreciated that separate elements may be used.

In any event, the first set of supports 20, 21, 22, allow processing electronics, connectors, or the like to be placed in the lower cavity 5, as shown by the dotted lines at 25. This can include:
1. Fibre optic cross connect patch panel, splice or joints;
2. Copper patch panels;
3. Installation Displacement Connection (IDC) modules;
4. Chassis mounting frames for digital/analogue electronics multiplexing devices and line or repeater amplifiers;
5. ISDN Repeaters;
6. Optical amplifiers/repeaters;
7. Broad band TV analogue/digital processing equipment; and,
8. Other electrical apparatus not mentioned above.

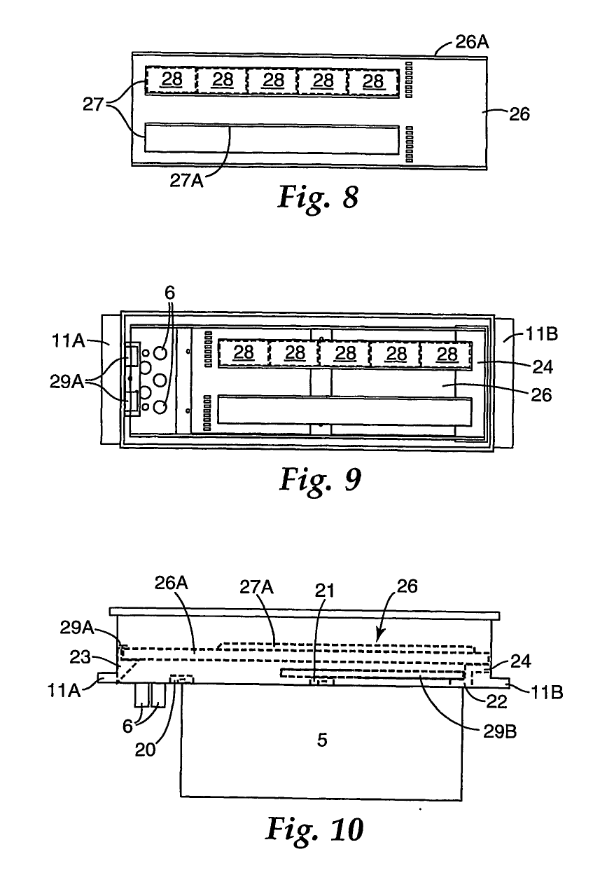

In an exemplary embodiment, the second set of supports 23, 24 are used to support a frame 26 having upright side portions 26A, shown in FIGS. 8 to 11. The frame includes two apertures, 27 having upright side portions 27A, are adapted to receive modules shown generally at 28.

These modules may be connection modules, such as:
1. Standard voice grade connection/disconnection modules;
2. High speed data modules;
3. Other similar IDC modules; and,
4. Fibre optic connectors.

Thus, it will be appreciated that the modules may be any form of module, but typically are connection modules suited to the termination of copper, fibre optic or coaxial type telecommunications signal cables.

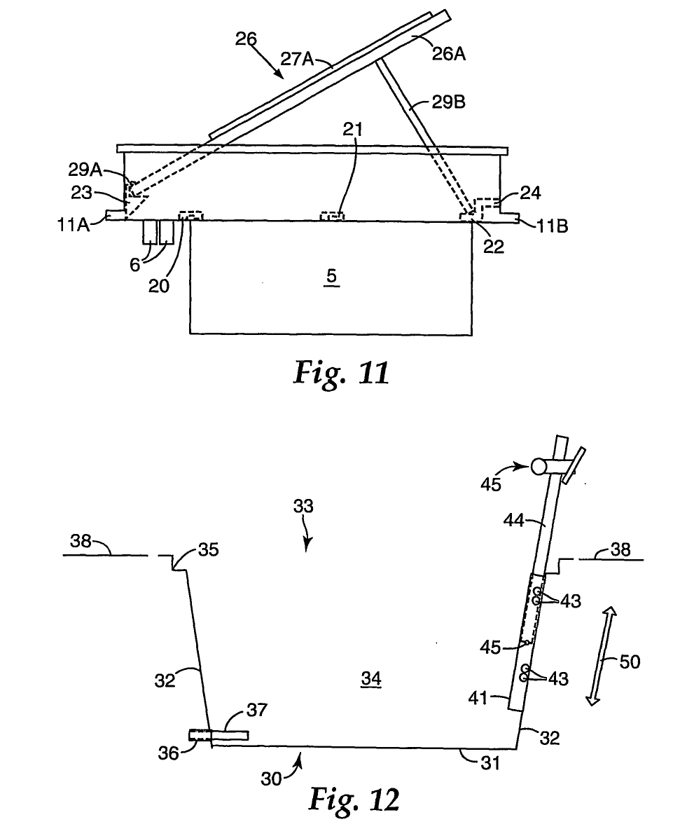

The frame 26 is pivotally mounted to the support 23 via a hinge 29 A, so as to move between a closed position shown in FIG. 10, and an open position shown in FIG. 11.

In the open position the frame 26 can be held in place by a support 29B, which can be retracted when not in use as shown in FIG. 10.

In any event, in use, cables may extend through the apertures 6, and pass along the frame 26 to suitable connections on a respective connection module 28. The cables can then be connected directly with other cables, by having the other cables attached to other suitable connections on the same connection module. Alternatively, the cable may be connected via suitable connections from the connection module 28, to the processing electronics or the like 25.

This allows processing, such as routing, encryption, compression, or format conversion to be performed within the processing electronics. This can be useful for example for converting optical signals from fibre optic cables into electrical signals for copper cabling, and vice versa.

It will be appreciated that any power requirements for on board processing may be obtained via power cabling routed through a respective aperture 6.

It will also be appreciated that alternative electronics and associated mountings may be used depending on the applications involved. Thus, for example, the supports 20, 21, 22, 23, 24 and the frame 26 may be replaced with alternative supports or mountings adapted to receive any electronic or other systems as required.

As mentioned above, the connection system may be placed in the ground to allow subsurface cabling to be interconnected. This is achieved by placing the connection system in a pit, the top of which is may be located at, above, or below ground level. An example of a suitable pit 30 is shown in FIGS. 12, 13 and 14. As shown, the pit 30 includes a base 31, and side walls 32 with an opening 33, which define a cavity 34. A lip 35 is generally provided to allow a lid to be fitted as will be described in more detail below.

The pit 30 may be formed from any suitable material, such as concrete, and may be pre-cast, or built on site. A conduit 36 is provided to receive cables or the like, as shown at 37. In this embodiment, the pit 30 is positioned at ground level 38.

In this embodiment, the pit includes a roller plate 41 coupled to the one of the side walls 32 and shaped to define a recess 42. The roller plate 41 supports four sets of rollers, two sets of which are shown at 43.

In use a loading arm 44 can be positioned in the recess 42 and is supported by a bolt or the like 45, which extends across the recess 42. The loading arm 44 includes a winch 45 as shown.

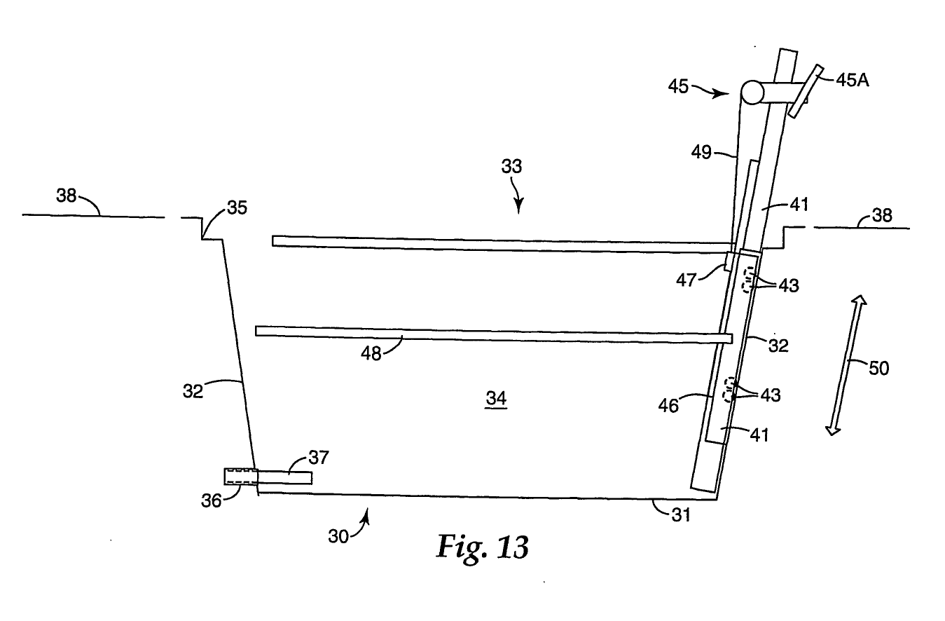

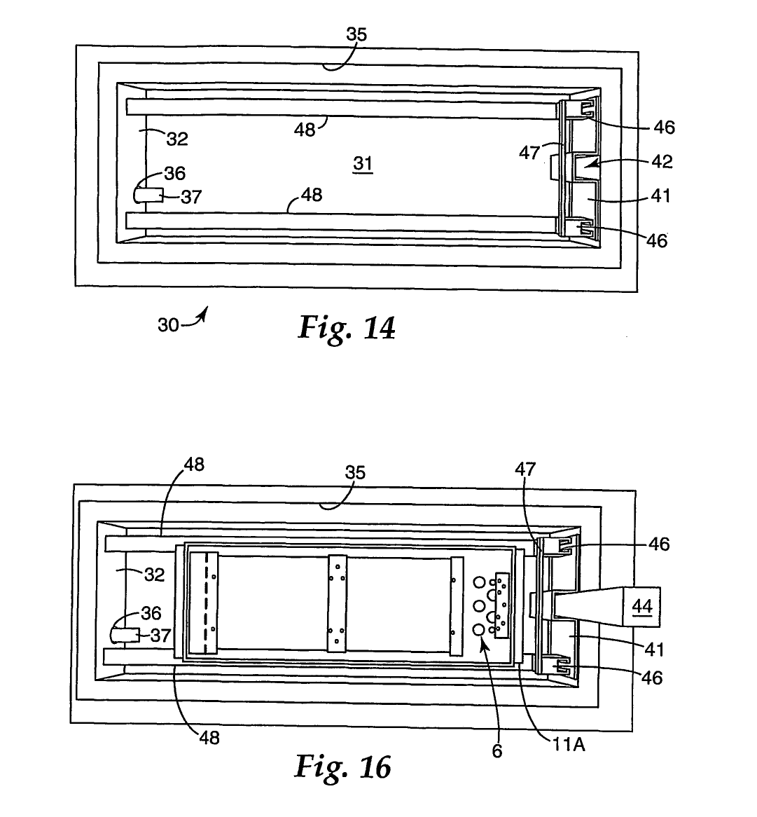

In use two rails 46 are adapted to be mounted to the rollers 43 as shown in FIGS. 13 and 14. The rails are coupled together via a support 47, and are adapted to support tines 48, which extend outwardly from the rails 46, substantially parallel to the base 31.

The support 47 is coupled to the winch 45 via a cable 49 to allow the rails 46 and the attached tines 48 to be moved in the direction of the arrow 50. The winch may be a hand driven winch, as shown. Alternatively however, powered drive systems or other suitable drive systems may also be used.

In any event, the drive system allows the tines 48 to be moved between a retracted position, as shown in FIG. 12, and an extended position shown in dotted lines. This allows the connection system to be positioned in the pit as will now be described with respect to FIGS. 14 to 16.

In the extended position bolts can be extended through the rails 46 as to abut the top of the recess 42. This allows the recess 42 to support the rails 46, thereby allowing the drive system 44, 45 to be removed whilst the tines 48 are held in the extended position. This is particularly useful during maintenance as it allows for easier access to the housing 1.

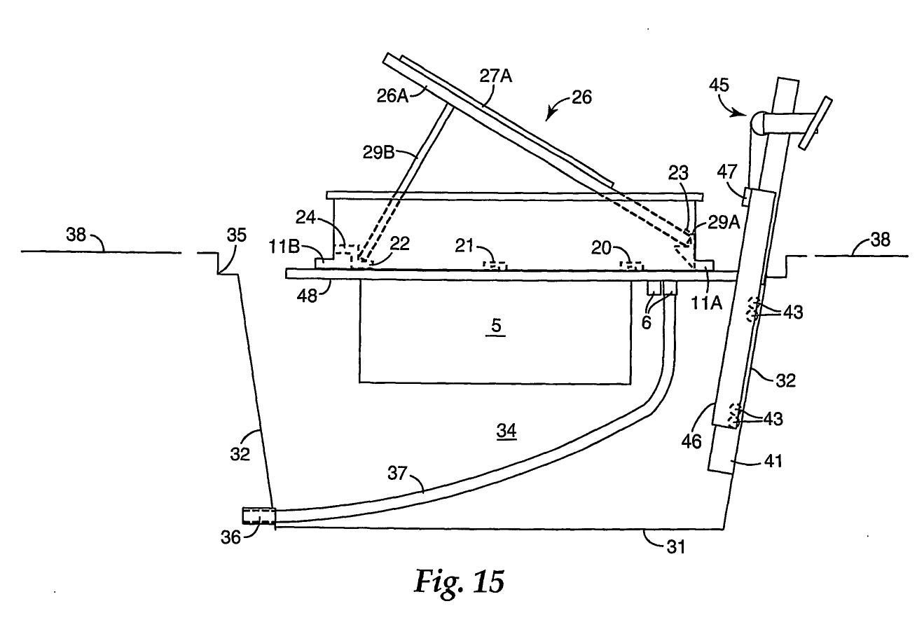

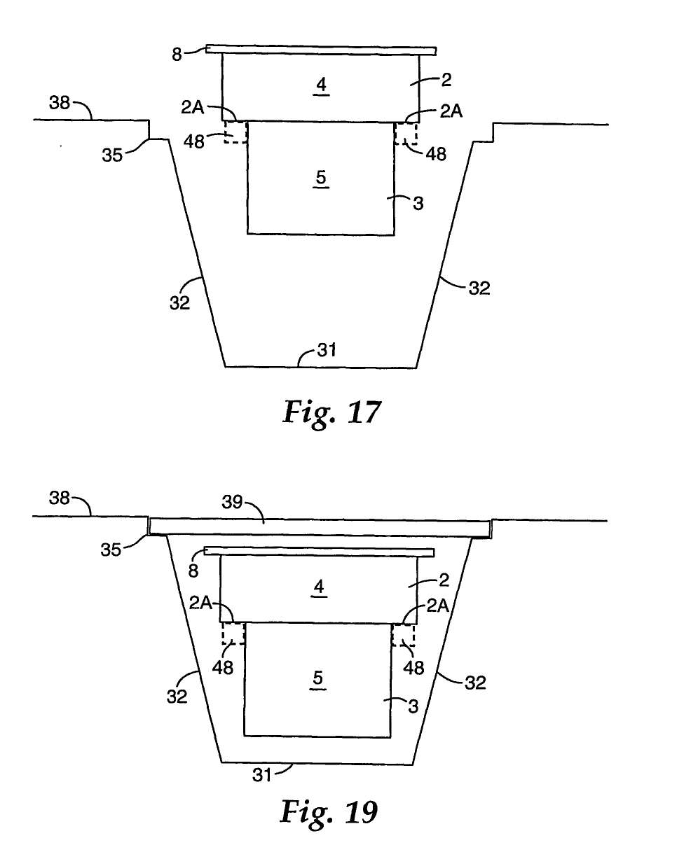

As shown in FIGS. 15, 16 and 17, when the connection system is initially placed on the tines 48, the tines are in the extended position, with the upper housing portion 2 supported by shoulders 2A, as shown. As a result, the upper housing portion 2 projects above the ground level 38. This allows access to the cavities 4, 5, to mount control electronics 25 and the like, as well as the frame 26.

As the housing is positioned in the pit, the cables 37 can be fed through the apertures 6 into the cavity 4. This is generally done as the housing is positioned in the pit, to ensure that the cables are not unduly stressed or bent, which can cause damage in some circumstances. After the cables are inserted in the apertures 6, then the apertures 6 are sealed, as described above to prevent moisture or dirt entering the cavity 4.

This allows the cables to be connected to appropriate connector modules 28, or control electronics 25, whilst the tines 48 are in the extended positions with the housing extending above ground level. This makes it easier for engineers or others to work on the connections.

Once the connections are completed, the support 29B can be retracted and the frame 26 may be moved to the closed position, with the lid 9 and cover 11 being mounted to the housing 1 to define the required air reservoir.

At this point the cover 10 and housing 1 may be coupled to the tines 48 by bolts or the like extending through the lips 11A, 11B, 14A and 14B. The bolts can typically be moved along the tines, for example by having the bolts cooperate with a mounting adapted to a slide along a recess in the tines. Thus allows the position of the housing 1 on the tines 48 to be adjusted during the mounting procedure to avoid undue stress on the cables 37.

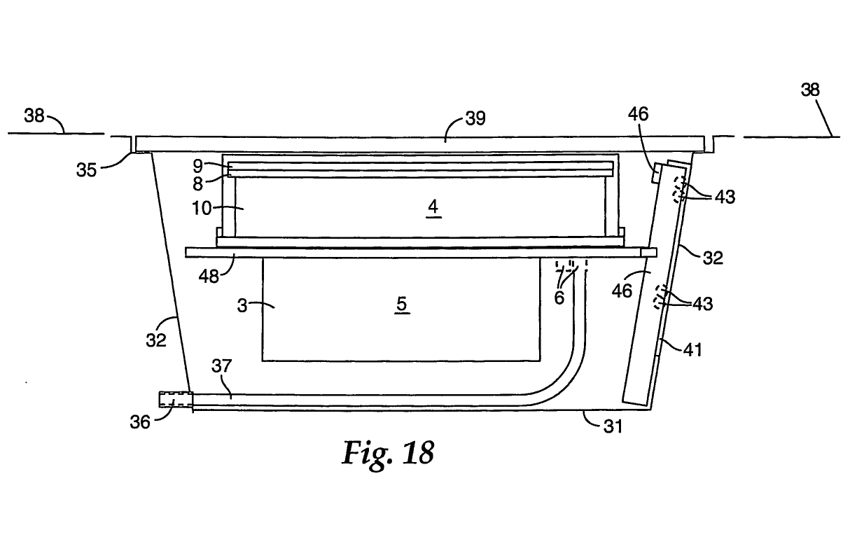

The tines 48 are then lowered using the drive system 44, 45, until the tines 48 are in the retracted position. At this point, the connection system is completely contained in the pit below ground level 38. The drive system 44, 45 can then be removed, allowing the pit 30 to be covered, by a suitable lid 39 or the like, to protect the junction box, as shown in FIGS. 18 and 19.

If future maintenance needs to be performed on the connection system, the lid can be removed from the pit, and the drive system 44, 45 remounted. The tines 48 can then be moved to the extended position, allowing the cover 10 and lid 9 to be removed and maintenance performed. The housing can even be removed from the pit if for example access is required to the cables 36 or the conduit 35.

It will be appreciated that the use of tines 48, the rails 46 and the winch 45 are not essential to the invention, and that any form of winch and corresponding support may be used. However, the tines advantageously support the housing 1 as shown, so that the housing 1 is supported above the housings centre of gravity, thereby ensuring the housing that can be raised and lowered in a stable manner, with the winch providing an easy and cheap mechanism via which this can be achieved.

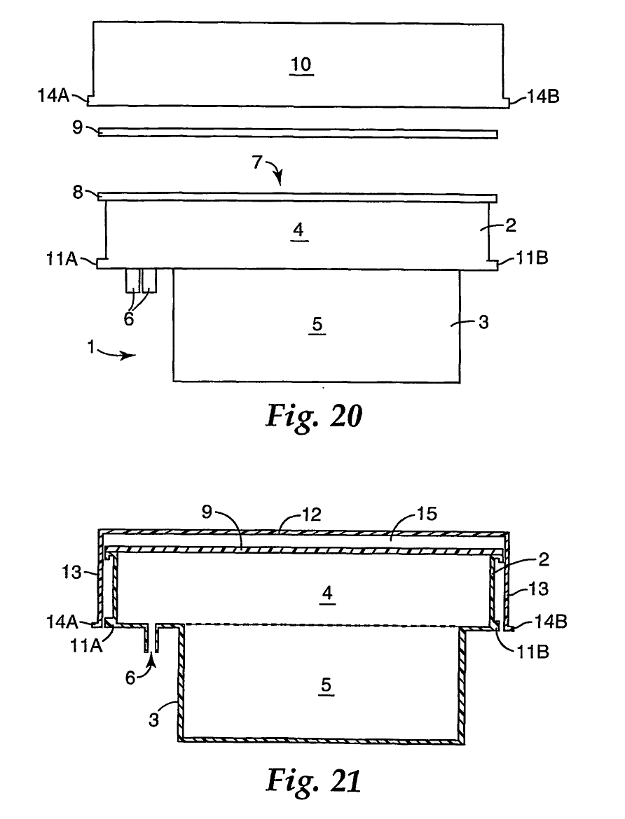

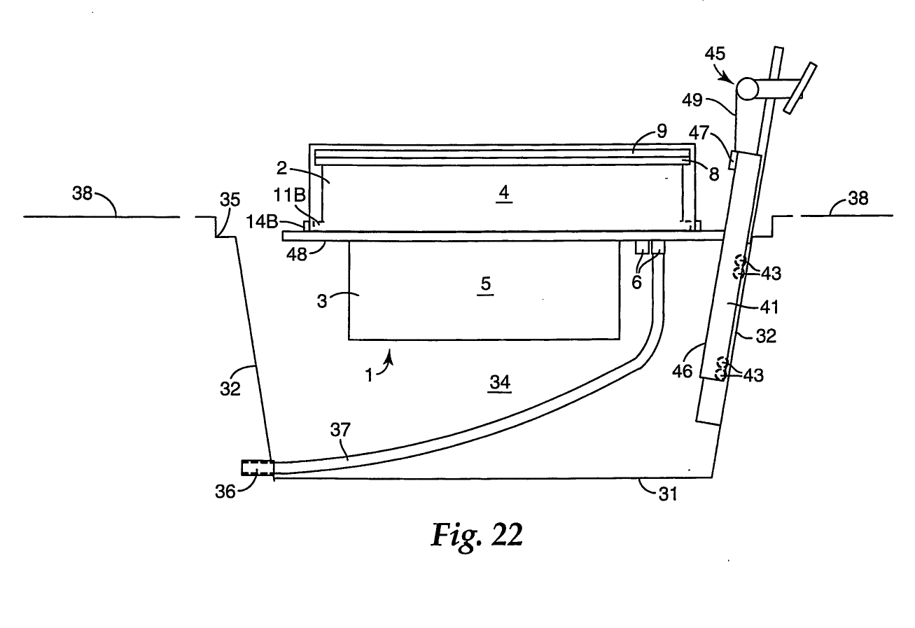

Another exemplary embodiment of a junction box according to the present invention is shown in FIGS. 20, 21 and 22. In this embodiment the majority of the components are identical to the embodiment described above and therefore will not be described in detail. The main distinction is that in this embodiment, the lips 11A, 11B are shortened and the cover 10 extended.

As a result, in use, the cover extends over the lips 11A, 11B as shown in FIG. 11. When mounted to the tines 48, the housing 1 can be attached to the tines 48 using a bolt extending through the lips 11A, 11B. The cover 10 can then be attached to the tines 48 separately via respective bolts extending through the lips 14A, 14B.

Again this is typically in such a manner as to allow the position of the bolts along the tines 48 to be adjusted, to thereby allow the position of the housing 1 and cover 10 to be moved along the tines 48, as described above.

This allows the cover 10 and lid 9 to be removed to allow access to the cavities 4, 5, without detaching the housing 1 from the tines 48, thereby aiding maintenance procedures.

It will be appreciated that the pit 30 and loading system 40 may be used in conjunction with any housing which may need to be mounted underground, although it is particularly suited for use with the connection system describe above.

Once mounted in the pit, the cavities 4, 5 are protected from contamination by dust and the like by the lid 9, and from immersion in water by the cover 11. It will be appreciated that the use of a lid and cover 11 in the manner described above to define an air reservoir may be used with any suitable housing and need not be restricted to the connection system described above.

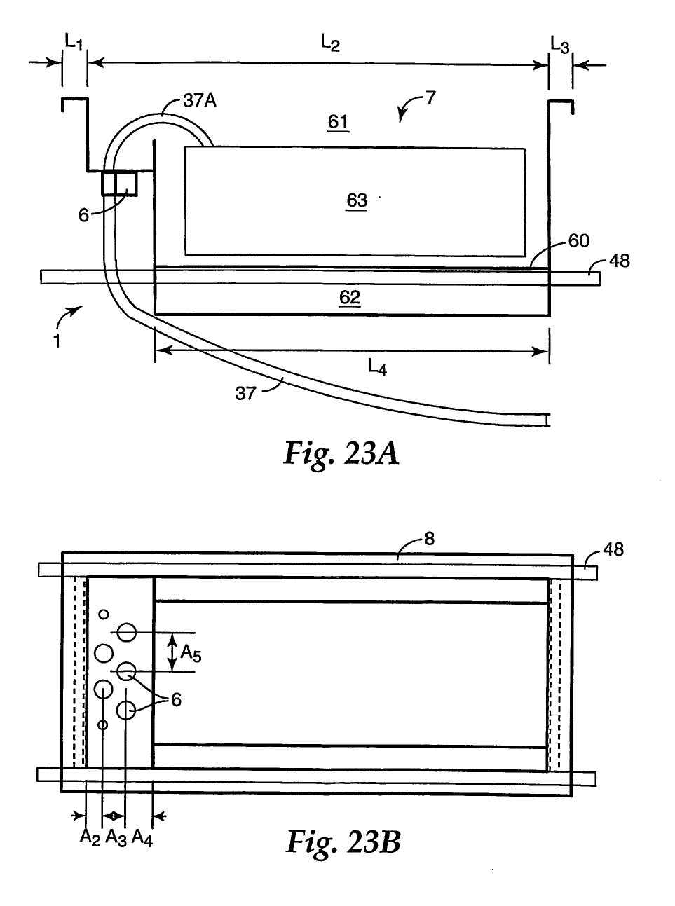

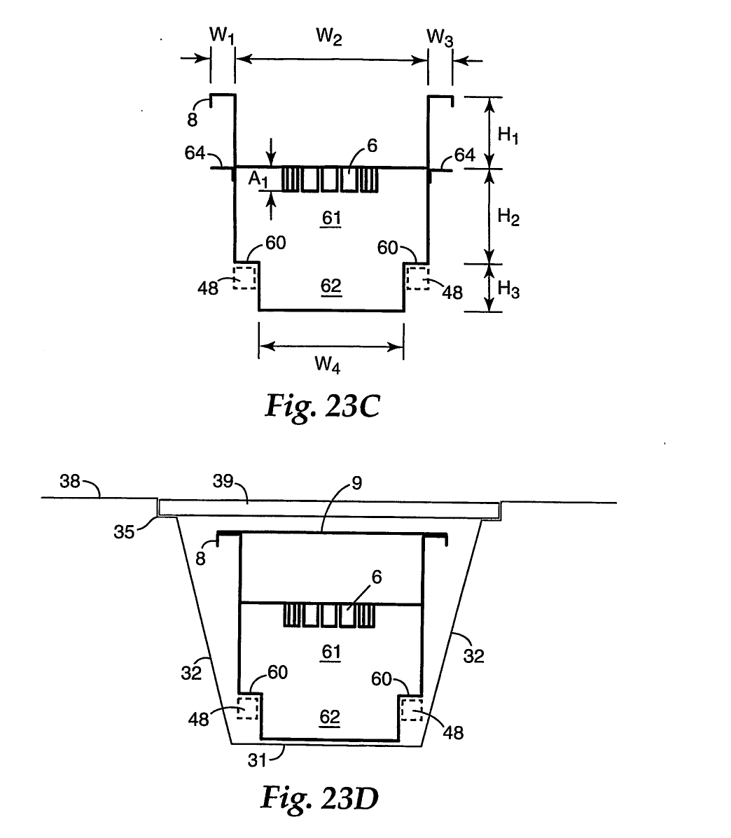

Another exemplary embodiment of a junction box according to the present invention is shown in FIGS. 23A, 23B and 23C. In this embodiment, the majority of the components are similar to those described above and will not therefore be described in detail, with similar reference numerals being used to identify similar elements.

In any event, in this embodiment, the housing 1 is modified as shown in the drawings, by lowering the support shoulders, shown at 60 in FIG. 23C, so that the housing 1 defines a cavity 61, equivalent to the previous cavity 4 and the cavity 5, and an additional cavity 62. In this embodiment, the shoulders 60 cooperate with the tines 48, which extend across the pit 30, to support the housing 1, in the manner described above with respect to the previous embodiments.

In use, a connection board is provided, as shown generally at 63. The connection board provides a mounting for any required processing electronics, and fibre optic connections and is adapted to provide similar functionality to the connection modules 28. This therefore obviates the need for the supports 20, 21, 22, 23, 24, the frame 26 and the modules 28, which in turn allows the connection board to extend into the cavity, thereby increasing the capacity of the connection board.

However, it will be appreciated that the supports 20, 21, 22, 23, 24, the frame 26 and the modules 28 may be incorporated into the housing 1 in the manner described above.

The housing also includes mountings 64, which are used to receive the cover, in a manner similar to the lip 11 shown in FIG. 1.

In one exemplary embodiment, the dimensions of the housing are as shown in Table 1.

TABLE 1

| | Length | | | | |
|---|---|---|---|---|---|
| Dimension | (mm) | Dimension | Length (mm) | Dimension | Length (mm) |
| L₁ | 20 | W₁ | 20 | A₁ | 50 |
| L₂ | 805 | W₂ | 320 | A₂ | 30 |
| L₃ | 20 | W₃ | 20 | A₃ | 40 |
| L₄ | 675 | W₄ | 240 | A₄ | 60 |
| L₅ | 450 | | | A₅ | 80 |

It will be appreciated that the housing will then be fitted with a lid 9 and a cover (not shown for clarity) and mounted in the pit 30 in the normal way, as shown in FIG. 23D.

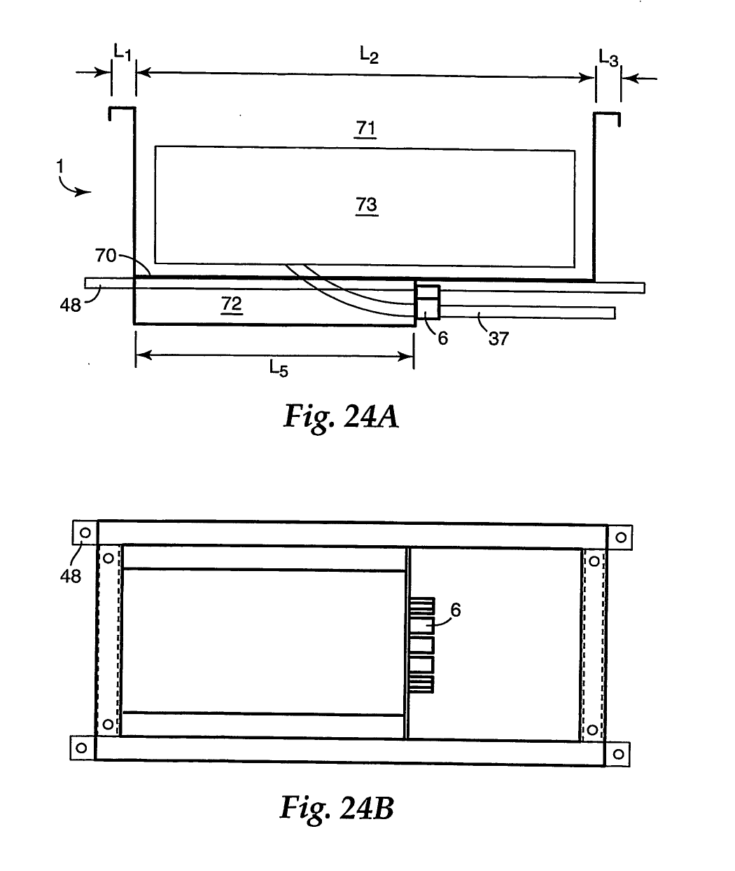

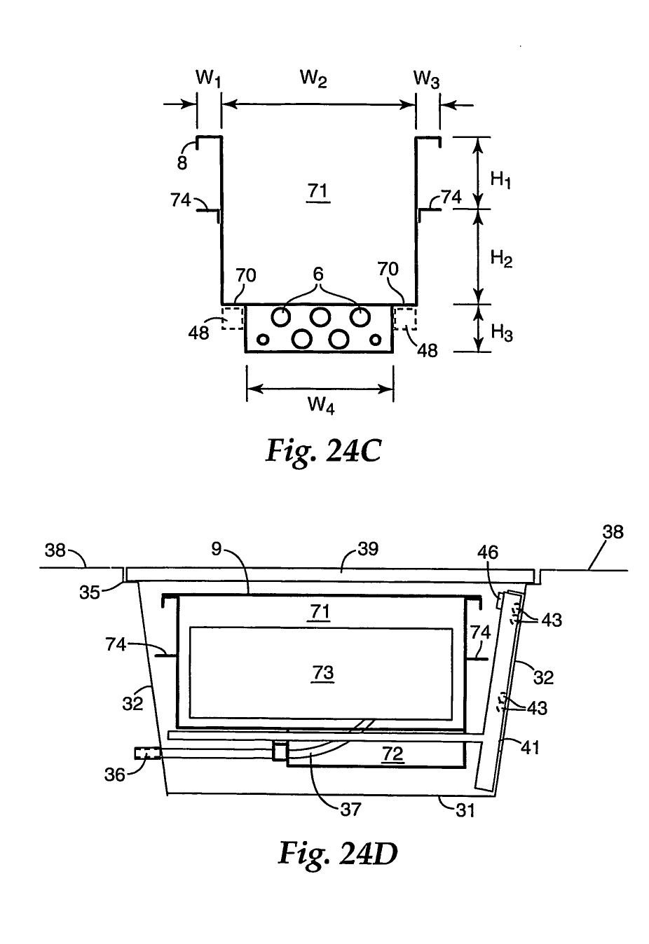

Another embodiment of a junction box according to the present invention is shown in FIGS. 24A, 24B and 24C. Again, in this embodiment, the majority of the components are similar to those described above and will not therefore be described in detail, with similar reference numerals being used to identify similar elements.

In any event, in this embodiment, the housing 1 is modified in a manner similar to that described above by having lowered shoulders 70, so as to define a single cavity 71, and a cavity portion 72. A connection board 73 is mounted in the cavity 71 and is adapted to operate substantially as described above.

In order to allow the housing 1 to be mounted in a pit, the shoulders 70 are used to allow the housing 1 to be supported by the tines 48, as shown in FIG. 24D. Mountings 74 are also provided for receiving the cover (not shown).

In this embodiment, the apertures 6 used for receiving the cable 37 are moved from the position shown in the previous embodiment, into one end of the cavity portion 72 as shown. The purpose behind this is to further reduce the bending of the cable 37. In particular, it can be seen in the embodiment of FIG. 23A, that whilst minimal bending of the cable 37 is required in order to allow the cable to enter the apertures 6, significant additional bending may be required in the cable portion 37A, to allow the cable to extend from the apertures 6 to the connection board 63.

Whilst this will not generally be an issue with copper based cabling, fibre optic cables are more sensitive to bending, and in particular can become damaged relatively easily. Accordingly, it will be appreciated that by allowing the system to be implemented with a reduce cable curvature, as shown in FIGS. 24A and 24D, this makes this configuration ideal for use with fibre optic cables.

Again, exemplary dimensions for this embodiment are shown in Table 1, above.

Persons skilled in the art will appreciate that numerous variations and modifications will become apparent. All such variations and modifications which become apparent to persons skilled in the art, should be considered to fall within the spirit and scope that the invention broadly appearing before described.

Thus for example, the positioning of the apertures 6 may be modified such that the apertures 6 are contained in the air reservoir 15 in use, thereby preventing water entering the housing between the aperture 6 and the cable 37. However, this is not generally essential, as it is relatively easy to provide a waterproof seal in this instance.

1) A connection system for interconnecting communication media, the connection system comprising:
a) A housing defining an internal cavity, the housing including an opening to thereby allow access to the cavity;
b) One or more apertures extending through the housing to the cavity, each aperture being adapted to receive respective communications media;
c) One or more connectors mounted within the cavity, the connectors being adapted to interconnect the communications media extending through the aperture(s);
d) A cover adapted to cooperate with the housing to define an air reservoir containing at least a portion of the housing including the opening, the reservoir and the housing cooperating to prevent fluid entering the cavity.

2) A connection system according to claim 1, the connection system further comprising a lid adapted to be removably mounted into the opening to thereby seal the cavity.

3) A connection system according to claim 1, wherein the connectors are coupled to a frame, the frame being pivotally mounted to the housing to move between:
a) A first position in which the frame is contained in the cavity; and,
b) A second position in which the frame extends through the opening to thereby allow access to the connectors.

4) A connection system according to claim 1, the cavity having first and second cavity portions, the connectors being mounted in the first cavity portion, the housing and cover being arranged such that the first cavity portion is contained in the air reservoir.

5) A connection system according to claim 4, the aperture(s) extending into the first cavity portion.

6) A connection system according to claim 4, the second portion of the housing being adapted to receive further connectors and/or control systems.

7) A connection system according to claim 1, the housing having first and second opposing ends, the opening being positioned at the first of the housing, the second end of the housing forming a base.

8) A connection system according to claim 7, the cover comprising an upper member having side members extend substantially perpendicularly therefrom, the cover being positioned adjacent the opening in use, such that the side members extend towards the base.

9) A connection system according to claim 1, the connection system further including a container having a container opening to thereby allow the housing and cover to be positioned in the container in use.

10) A connection system according to claim 9, the container being positioned in the ground in use, with the housing positioned below ground level, with the communications media extending into the container through an aperture from a below ground level conduit.

11) A container for containing a connection system for interconnecting communication media, the container including comprising:
a) A cavity;
b) A loading system mounted in the cavity, the loading system comprising:
i) Two or more tines extending laterally across the container, the times being adapted to support the connection system in use;
ii) A drive system positioned in a first end of the container, the drive system being coupled to the tines to selectively move the tines between:
(1) A retracted position in which the connection system is supported in the container below ground level; and,
(2) An extended positioned in which at least a portion of the connection system extends above ground level.

12) A container according to claim 11, the drive system including a winch coupled to one end of the container to thereby allow the tines to be manually winched between the retracted and extend positions.

13) A container according to claim 11, the connection system comprising a connection system according to claim 1.

14) A container according to claim 13, wherein the tines are adapted to cooperate with the housing defining the first cavity portion.

15) A method of interconnecting communications media, the method including:
a) Extending the communications media into an internal cavity defined by a housing through one or more apertures, the housing having an opening therein to thereby allow access to the cavity;
b) Interconnecting the media using one or more connectors mounted within the cavity; and,
c) Positioning a cover over the housing such that the housing and cover cooperate to define an air reservoir containing at least a portion of the housing including the opening, the reservoir and the housing cooperating to prevent fluid entering the cavity.

16) A method according to claim 15, the step of extending the communications media through the aperture including:
a) Inserting the communications media into the cavity through the aperture(s); and,
b) Sealing the aperture, to thereby prevent fluid entering or leaving the cavity through the aperture.

17) A method according to claim 15, the method further including positioning the housing in a container through a container opening.

18) A method according to claim 17, the method further including:
a) Positioning the housing adjacent the container;
b) Extending the communications media into the cavity;
c) Interconnecting the communications media; and,
d) Positioning the housing in the container.

19) A method according to claim 15, the housing having first and second opposing ends, the opening being positioned at the first of the housing, the second end of the housing forming a base, the cover comprising an upper member having side members extend substantially perpendicularly therefrom, the method including positioning the cover adjacent the opening in use, such that the side members extend towards the base.

20) A method according to any claim 15, the method further including removably mounting a lid in the opening to thereby seal the cavity.

21) A method according to claim 15, the method including using a connection system according to claim 1.

22) A method of loading a connection system into a container, the method including using a loading system to position the housing in the container, the loading system including:
a) Two or more tines extending laterally across the container, the times being adapted to support the housing in use;
b) A drive system positioned in a first end of the container, the drive system being coupled to the tines to selectively move the tines between:
i) A retracted position in which the housing is supported in the container below ground level; and,
ii) An extended positioned in which at least a portion of the housing extends above ground level;
the method including positioning the housing in the container by:
(1) Placing the tines in the extended position;
(2) Positioning the connection system such that the connection system is supported by the tines;
(3) Moving the times to the retracted position.

23) A method according to claim 22, the connection system comprising a connection system according to claim 1.

24) A method according to claim 23, the method of interconnecting the communications media including:
a) Positioning the housing such that the housing is supported by the tines with the tines in the extended position;
b) Placing the frame in the second position;
c) Interconnecting the communications media;
d) Placing the frame in the first position;
e) Removably mounting a lid in the opening to thereby seal the cavity;
f) Positioning a cover over the housing such that the housing and cover cooperate to define an air reservoir containing at least a portion of the housing including the opening, the reservoir and the housing cooperating to prevent fluid entering the cavity; and
g) Moving the tines to the retracted position.

25) A system for protecting contents against immersion in a fluid, the system comprising:
a) A housing defining an internal cavity for containing the contents, the housing including an opening to thereby allow access to the cavity; and,
b) A cover adapted to cooperate with the housing to define an air reservoir containing at least a portion of the housing including the opening, the reservoir and the housing cooperating to prevent fluid entering the cavity.

26) A system according to claim 25, the cover comprising a base member having a number of side members extending perpendicularly thereto, the base member and sided members being arranged such that the side and base members cooperate with the housing to define an air reservoir.

27) A system according to claim 26, the housing having a base for supporting the housing in use, and a top opposite the base, wherein in use, the cover is adapted to be positioned adjacent the top such that the side members extend toward the base.

28) A system according to claim 27, the opening being in the top.

29) A method of protecting contents against immersion in a fluid, the method including:
a) Placing the contents in a housing defining an internal cavity, the housing including an opening to thereby allow access to the cavity; and,
b) Mounting a cover to the housing, the cover being adapted to cooperate with the housing to define an air reservoir containing at least a portion of the housing including the opening, the reservoir and the housing cooperating to prevent fluid entering the cavity.
